(19) United States
(12) Patent Application Publication
(10) Pub. No.: US 2008/0222901 A1
(43) Pub. Date: Sep. 18, 2008

(54) Hand-Guided Power Jigsaw

(76) Inventors: Hans Kaiser, Leuzigen (CH); Joachim Schadow, Leinfelden-Echterdingen (DE); Marcel Casota, Gelterkinden (CH); Paul Stooss, Flumenthal (CH); Daniel Saegesser, Langenthal (CH)

Correspondence Address: MICHAEL J. STRIKER, 103 EAST NECK ROAD, HUNTINGTON, NY, 11743, US

(21) Appl. No.: 12/089,691

(22) PCT Filed: May 4, 2007
(86) PCT No.: PCT/EP2007/054361

§ 371 Date: Apr. 9, 2008

(30) Foreign Application Priority Data
Jul. 3, 2006 (DE) 10 2006 030 558.2

(51) Int. Cl. B23D 49/10

(52) U.S. Cl. 30/392

(57) ABSTRACT

The invention relates to a handheld hacksaw with a saw blade that can be moved to and fro, an effective support device (20) in the direction of sawing, with a support element (21) that supports the back of the saw blade, a holder (22) that holds the support element (21) between two sides (222, 223), and guide elements (26, 27) with facing guide surfaces (261, 271) on the two sides of the saw blade facing away from each other. To reduce the production costs for the handheld hacksaw by ensuring a simple design of the guide elements adequate for high-quality sawing, the guide elements (26, 27) have a fixed horizontal spacing of the guide surfaces (261, 271) thereof, perpendicular to the direction of sawing at the ends of the sides (222, 223) of the holder (22).

### PRIOR ART

The invention is based on a hand-guided power jigsaw as defined by the preamble to claim 1.

A known hand-guided power jigsaw, also referred to as a hand-guided compass saw (DE 101 19 561 A1) has a support device with a U-shaped holder mounted in oscillating fashion to the housing of the compass saw and has a support roller, which is situated between the legs of the holder and supports the saw blade at its saw blade spine. The support roller is provided with a V-shaped groove that accommodates the spine of the saw blade. A guide means is provided in order, during sawing, to prevent a lateral deflection of the oscillating device transversely in relation to the sawing direction. The guide means is mounted on the housing of the compass saw or on a base plate that permits the compass saw to rest on the work piece to be sawn. The guide means is embodied as bifurcated and at the ends of the forks, supports guide jaws oriented toward each other, which engage the holder of the oscillating device, particularly in the region of the holder in which the support roller is situated.

A known hand-guided compass saw (WO 02/22297 A1) has a support device with a support roller that supports the saw blade in the sawing direction along its saw blade spine and is capable as needed of driving it to oscillate in the sawing direction. In order to prevent a lateral deflection of the saw blade transverse to the sawing direction during the sawing process, the compass saw has a guide device for guidance and lateral support of the saw blade, which device has two guide elements resting on opposite blade sides of the saw blade; the compass saw also has an actuating motor embodied in the form of a spring drive with which it is possible to adjust the distance between the guide elements to the saw blade thickness. The guide device is coupled to a clamping device holding the saw blade so that the guide elements are lifted away from the saw blade when the clamping device is opened and are placed against the blade sides of the saw blade when the clamping device is closed. It is alternatively for the guide elements to be moved into position separately. The guide elements are embodied in the form of rolling elements or ceramic components, each of which is mounted on the lever arm of a two-armed swiveling lever. The swiveling levers, which are embodied in the form of the arms of a pair of pliers, are connected to each other via an articulating joint and, by means of guide pins that protrude from their lever arms oriented away from the guide elements, engage in grooves of a bearing component, which grooves are embodied as tapering outward slightly at an angle of less than 60 in the longitudinal direction of the saw blade. With the movement of the bearing component, the swiveling levers are swiveled via the groove flanks and the guide pins. The bearing component is engaged by two compression springs that load the bearing component in the longitudinal direction of the saw blade and strive to move the swiveling levers via the grooves of the guide pins so that the guide elements on the swiveling levers come to rest with a spring prestressing force against the blade sides of the saw blade. A self-locking action prevents an opening of the guide elements when they are subjected to a load.

### DISCLOSURE OF THE INVENTION

The hand-guided power jigsaw with the defining characteristics of claim 1 has the advantage that a lateral support and guidance of the saw blade that is sufficient for producing high-quality kerfs is achieved in an extremely simple structural fashion so that the production costs for the hand-guided power jigsaw are reduced. Furthermore, with an oscillating suspension of the holder of the support device, the guide elements move along with the oscillating motion of the holder and the support element so that the lateral support and guidance of the saw blade viewed in the sawing direction always occurs at the same location and can therefore be positioned a very great distance from the spine of the saw blade, as close as possible to the tooth gullet of the row of teeth, without the danger of the row of teeth coming into contact with the guide surfaces. A maximum distance of the guide surfaces from the spine of the saw blade assures an optimal lateral guidance and support of the saw blade.

Advantageous modifications and improvements of the hand-guided power jigsaw disclosed in claim 1 are possible by means of the steps taken in the remaining claims.

According to an advantageous embodiment of the invention, the lateral distance between the guide surfaces of the two guide elements situated opposite each other is dimensioned so that it is greater than the maximum blade thickness of a saw blade approved for saw blade replacement, plus a required minimum play for this saw blade between the guide surfaces. Consequently, saw blades with a narrow blade thickness are in fact guided with a correspondingly greater amount of play between the two guide surfaces, but this does not have any appreciable negative effect on the quality of the cutting result.

### BRIEF DESCRIPTION OF THE DRAWINGS

The invention will be explained in greater detail in the description below in conjunction with an exemplary embodiment shown in the drawings.

FIG. 1 is a perspective, schematically depicted view of a hand-guided power jigsaw with a clamped saw blade and a support device for the saw blade,

FIG. 2 shows a section of a perspective view of the support device in FIG. 1,

FIG. 3 is a bottom view of the support device in the direction of the arrow III in FIG. 2,

FIG. 4 is a perspective side view of a holder of the support device in FIG. 2,

FIG. 5 is a front view of a support element of the support device in FIG. 2.

### EMBODIMENT OF THE INVENTION

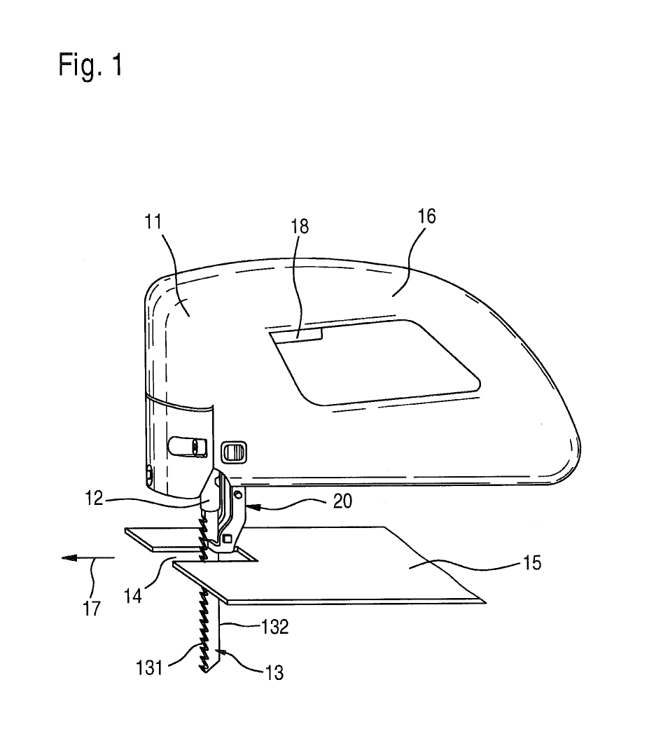

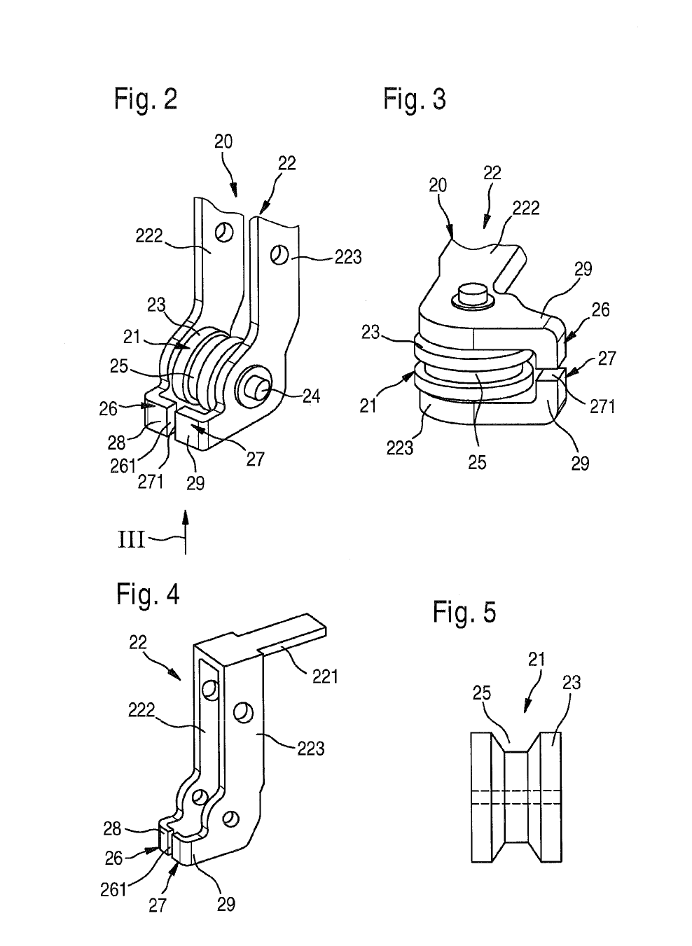

The hand-guided power jigsaw or hand-guided compass saw depicted in schematic fashion in FIG. 1 has a machine housing 11 in which an electric motor with a transmission is situated in order to drive a lifting rod 12 into an up-and-down stroke motion. The clamping shaft of a saw blade 13 is detachably affixed to the lifting rod 12. The saw blade 13, which has a row of saw teeth 131 and a saw blade spine 132 oriented away from these teeth, is guided through an opening 14 in a base plate 15. The baseplate 15 is attached to the machine housing and during use of the hand-held power jigsaw, is placed onto the tool to be sawn. The electric motor of the hand-guided power jigsaw is switched on and off by means of a pushbutton 18, which is situated on the underside of a handle 16 formed into the machine housing 11.

In order to prevent a deflection of the free end of the saw blade 13 during sawing and an accompanying lack of quality in the sawing result, on the one hand, the saw blade 13 is supported along the spine of the saw blade 132 and on the other hand, is guided on its opposing blade sides in order to minimize a lateral deflection of the saw blade 13. To this end, a support device 20 is provided, which acts in the sawing direction (arrow 17 in FIG. 1) and which has a U-shaped holder 22 (FIG. 4) with two legs 222, 223 connected to each other by means of a cross piece 221 as well as a support element 21 accommodated in the holder 22 (FIG. 5). In the exemplary embodiment shown, the support element 21 is embodied in the form of a support roller 23 that is supported on an axle 24 supported in the two legs 222, 223. In the middle, the support roller 23 has a circumferential groove 25 with a V-shaped or inwardly tapering trapezoidal cross-section. The holder 22 is inserted into the machine housing 11 behind the saw blade 13 in the sawing direction and is attached there (FIG. 1). During the reciprocating motion of the saw blade 13, the spine of the saw blade 132 rests against either the groove base or the groove sides of the circumferential groove 25, depending upon the blade thickness or blade strength. The support device 20 can also be mounted in the machine housing 11 so that the holder 22 is able to oscillate; during the sawing process, the oscillating motion of the holder 22 causes the support roller 23 to drive the saw blade 13 to oscillate in the sawing direction (arrow 17 in FIG. 1).

Guide elements 26, 27 equipped with guide surfaces 261, 271 oriented toward each other are provided on the holder 22, in particular at the free ends of the legs of the holder 22, to laterally guide the saw blade 13. The guide surfaces 261, 271—viewed transversely in relation to the sawing direction 17—have a fixed lateral distance, which is dimensioned so that it is greater than the maximum blade thickness of a saw blade approved for saw blade replacement by a minimum guidance play for the saw blade 13 moving through between the guide surfaces 261, 271. In this case, the guide elements 26, 27 are embodied so that their guide surfaces 261, 271, viewed in the stroke direction of the saw blade 13, lie beneath the support point of the support element 21 against the spine of the saw blade 132, i.e. below the pressure point of the support roller 23 against the spine of the saw blade 132. In order to implement the lateral distance between the guide surfaces 261, 271 that is matched to the saw blade thickness, the guide elements 26, 27 are embodied in the form of leg extensions 28, 29 bent at right angles, which are situated at the leg ends. The guide elements 26, 27 are joined, for example integrally, to the legs 222, 223, but in lieu of this, can also be affixed to them in a nondetachable or detachable fashion. The guide surfaces 261, 271 are situated at the free ends of the leg extensions 28, 29. The leg extensions 28, 29, with their right-angle bend oriented toward the saw blade 13, are embodied so that the guide surfaces 261, 271 are situated close to the tooth gullet of the row of saw teeth 131 and therefore assume the greatest possible distance from the spine of the saw blade 132. In this way, a lateral saw blade guidance is implemented, which has an optimum distance from the pressure point of the support roller 23. At the same time, the row of saw teeth 131 of the saw blade 13 is prevented from traveling into the region of the guide surfaces 261, 271 during the stroke motion.

The guide elements 26, 27 can also be embodied in the form of separate components that are attached to the legs 222, 223 of the holder 22 in a replaceable fashion. The holder 22 with the legs 222, 223 can also be embodied in the form of a stamped or bent component and, for the guide elements 26, 27 that support the guide surfaces 261, 271, can have hard metal parts soldered or welded onto them.

What is claimed is:

1. A hand-guided power jigsaw having a saw blade (13), which is drivable in a reciprocating motion and has both a row of saw teeth (131) and, oriented away from these teeth, a saw blade spine (132); having a support device (20) that is effective in the sawing direction (17) and that has a support element (21) resting against the spine of the saw blade (132) and a holder (22) that accommodates the support element (21) between two legs (221, 222); and
having guide elements (26, 27) resting against opposite blade sides of the saw blade (13) for laterally guiding the saw blade (13), which guide elements have guide surfaces (261, 271) oriented towards each other,
wherein the guide elements (26, 27) are situated on the legs (222, 223) of the holder (22) and their guide surfaces (261, 271) have a fixed lateral distance from each other, viewed laterally in relation to the sawing direction (17).

2. The hand-guided power jigsaw as recited in claim 1,
wherein the lateral distance between the guide surfaces (261, 271) is dimensioned to be greater by a minimum saw blade guidance play than the maximum blade thickness of a saw blade (13) approved for saw blade replacement.

3. The hand-guided power jigsaw as recited in claim 1,
wherein the guide elements (26, 27) are embodied so that their guide surfaces (261, 271), viewed in the stroke direction of the saw blade (13), lie beneath the support point of the support element (21) against the spine of the saw blade (132).

4. The hand-guided power jigsaw as recited in claim 1,
wherein the guide elements (26, 27) are embodied so that their guide surfaces (261, 271) are situated close to the tooth gullet of the row of saw teeth (131) of the saw blade (13).

5. The hand-guided power jigsaw as recited in claim 1,
wherein the guide elements (26, 27) are affixed to the leg ends of the legs (222, 223) in a nondetachable or detachable fashion or are integrally joined to the legs (222, 223).

6. The hand-guided power jigsaw as recited in claim 5,
wherein the guide elements (26, 27) are composed of leg extensions (28, 29) that are bent at right angles at the leg ends of the legs (222, 223) and the guide surfaces (261, 271) are situated on the free end surfaces of the leg extensions (28, 29).

7. The hand-guided power jigsaw as recited in claim 1,
wherein the support element (21) is embodied in the form of a support roller (23) equipped with a circumferential groove (25) that rests against the spine of the saw blade (132) and the support roller (23) is situated in rotary fashion between the legs (222, 223) of the holder (22).

8. The hand-guided power jigsaw as recited in claim 1,
wherein the holder (22) is mounted to a machine housing (11), preferably in an oscillating fashion.
